(19) United States
(12) Patent Application Publication
(10) Pub. No.: US 2013/0148064 A1
(43) Pub. Date: Jun. 13, 2013

(54) Manufacturing Method of Color Film Substrate, Liquid Crystal Display Panel, and Liquid Crystal Display Device

(71) Applicants: Minghung Shih, Shenzhen (CN); Zhenghua Li, Shenzhen (CN)

(72) Inventors: Minghung Shih, Shenzhen (CN); Zhenghua Li, Shenzhen (CN)

(21) Appl. No.: 13/379,104

(22) PCT Filed: Dec. 4, 2011
(86) PCT No.: PCT/CN2011/083430

§ 371 Date: Jan. 24, 2013

(30) Foreign Application Priority Data
Nov. 29, 2011 (CN) 201110386869.0

(51) Int. Cl. B05D 5/06; G02F 1/1333

(52) U.S. Cl. CPC B05D 5/06; G02F 1/1333
USPC 349/123; 427/162

(57) ABSTRACT

The present invention discloses a manufacturing method of color film (CF) substrate, a liquid crystal display (LCD) panel, and an LCD device. The purpose of the present invention is achieved by the following technical schemes. A manufacturing method of the CF substrate, wherein the manufacturing method comprises the steps: forming photo spacer (PS) on the CF substrate, and then forming an alignment layer on the CF substrate. The present invention, by using the PS contacting with an array substrate and a CF substrate, replaces the manufacture procedure of the electrode layer with the manufacture procedure of the PS, and the CF substrate is formed with PS; the electrode layer is then formed and the surface of the electrode layer opposite to the substrate is covered by the electrode layer. So the PS can transmit the pixel electrode signal to the CF substrate to replace the Au ball. Thus, in the manufacturing technique of the LCD, the spread technology of the Au ball and the reticle design of the transfer pad can be omitted, and the material demand of the Au ball can also be omitted.

### TECHNICAL FIELD

The present invention relates to the field of liquid crystal displays (LCDs), and more particularly to a manufacturing method of color membrane substrate, an LCD panel, and an LCD device.

### BACKGROUND

The LCD panel is the important assembly of the LCD device, including: an array substrate, a color film (CF) substrate, and liquid crystal molecules; the liquid crystal molecules are positioned between the array substrate and the CF substrate.

As shown in FIG. 1, in the existing structure of the LCD panel, a liquid crystal capacitor CLC (the capacitor between the pixel electrode and the common electrode) is formed by the pixel electrode 24 (ITO electrode) on the side of array substrate 20 and the common electrode 14 (ITO electrode) on the side of CF substrate 10; the photo spacer (PS) 13 is formed on the black matrix (BM) 12; the color filter coating 11 is positioned between the BM 12, wherein the electric connection is formed between the common electrode 14 on the side of the CF substrate 10 and the pixel electrode 24 on the array substrate 20. In prior art, the industry generally adopts the method that manufactures transfer pad in the frame sealant outside the AA area (visible area) on the side of the array substrate, and then performs Au ball spread during the manufacture procedure stage of liquid crystal box, to form the electric connection between the pixel electrode and the common electrode. As shown in FIG. 1, the electric connection is achieved by spreading the Au ball 16 in the transfer pad 15; that is to say, Au ball 16 is electrically connected to the pixel electrode 24 on the array substrate 20, and is electrically connected to the common electrode 14 on the CF substrate 10 simultaneously. This requires that the position of the transfer pad should be considered during reticle design, and the Au ball is one aspect of the cost of raw materials used in the manufacture procedure stage of the liquid crystal box.

As shown in FIG. 2, the general manufacture procedure of the CF substrate of the existing LCD panel includes manufacturing ITO film after completing the manufacture of BM and color filter coating (RGB) sub-pixel, and then forming PS; the function of CF substrate is to support two layers of glass substrates and control the gap of the liquid crystal box. Then Au ball is spread on the CF substrate during the manufacture procedure stage of the liquid crystal box.

### SUMMARY

The aim of the present invention is to provide the manufacturing method of CF substrate, LCD panel, and LCD device which has the advantages of simple process and low cost.

The purpose of the present invention is achieved by the following technical schemes: a manufacturing method of CF substrate comprises the steps: forming PS on the CF substrate, and then forming alignment layer on the CF substrate.

Preferably, the frame sealant setting area of the CF substrate is also formed with PS. Correspondingly, the alignment layer is formed above all the PSs. The PS is made to set up in the frame sealant to replace the Au ball preferably.

A manufacturing method of the color film substrate , comprising the steps:

A: forming a BM and a color filter coating;

B: forming PS;

C: forming alignment layer.

An LCD panel , comprising: opposed array substrate and CF substrate; the CF substrate is formed with PS and an alignment layer, the surface of the PS opposite to the array substrate is covered by the alignment layer; the alignment layer on the PS is connected with the pixel electrode of the array substrate on the LCD panel by signal.

Preferably, the frame sealant setting area of the CF substrate is provided with PS, and the upper surface of the PS is covered by the alignment layer. The surface of PS is made to have electrode layer so that the PS can replace the Au ball to conduct.

Preferably, the alignment layer on the PS contacts the pixel electrode of the array substrate on the LCD panel to perform signal connection. The PS is made to transmit the signal of array substrate to the CF substrate.

Preferably, the electrode layer is made of ITO material. ITO material is the better electrode material which has the advantage of transparent material that has no influence on light transmittance of the pixel.

An LCD device comprises the aforementioned LCD panel.

The present invention, by using the PS contacting with an array substrate and a CF substrate, replaces the manufacture procedure of the electrode layer with the manufacture procedure of the PS, and the CF substrate is formed with PS; the electrode layer is then formed, and the surface of the electrode layer opposite to the substrate is covered by the electrode layer. Therefore the PS can transmit the pixel electrode signal to the CF substrate to replace the Au ball. Thus, in the manufacturing technique of the LCD, the spread technology of the Au ball and the reticle design of the transfer pad can be omitted, and the demand of the Au ball material can also be omitted.

### BRIEF DESCRIPTION OF FIGURES

FIG. 1 is the structural diagram of the existing LCD panel;

FIG. 2 is the manufacturing process sketch of the CF substrate in the existing LCD panel;

FIG. 3 is a structural diagram of embodiment of an LCD panel of the present invention;

FIG. 4 is a manufacturing process sketch of the CF substrate in the embodiment of the present invention.

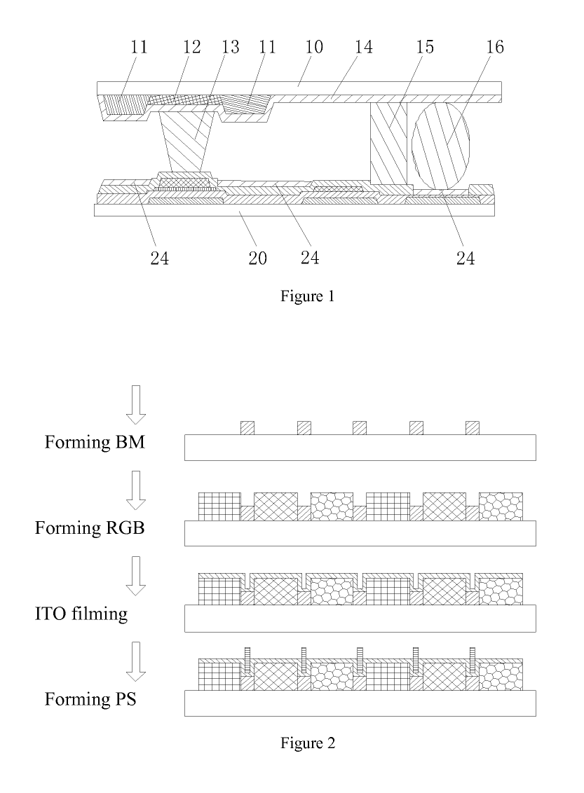

Wherein: 10. CF substrate; 11. color filter coating; 12. BM; 13. PS; 14. common electrode; 15. frame sealant; 20. array substrate; 24. pixel electrode.

### DETAILED DESCRIPTION

The present invention will further be described in detail in accordance with the figures and the preferred embodiments.

The present invention provides an LCD device; the LCD panel of the LCD device includes the CF substrate. The CF substrate is formed with color filter coating, PS, and electrode layer. The color filter coating and the PS are formed with the electrode layer. The manufacturing method of LCD panel includes the following steps: A . CF substrate is formed with BM and color filter coating; B. forming PS; C. forming electrode layer.

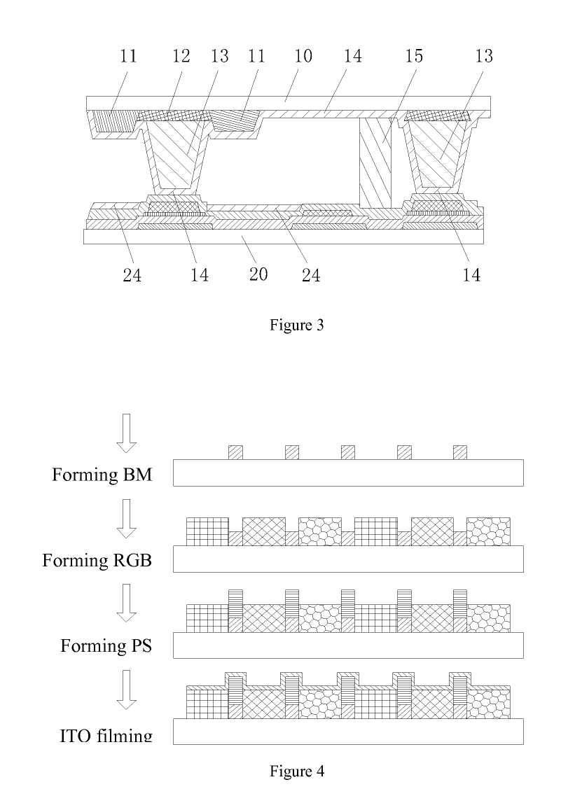

FIG. 3 is the embodiment of the present invention, in the LCD panel structure of the LCD device, a liquid crystal capacitor CLC (the capacitor between the pixel electrode and the common electrode) is formed by the pixel electrode 24 on the side of array substrate 20 and the common electrode 14 on the side of CF substrate 10; the PS 13 is formed on the BM 12; the color filter coating 11 is positioned between the BM 12; the upper surface of BM 12 and PS 13 are covered by the common electrode 14; and the common electrode 14 on the side of the CF substrate 10 contacts with the pixel electrode 24 on the array substrate 20 by the PS 13 to perform signal connection. Not only the liquid crystal box is formed with the PS 13, but also the transfer pad in the frame sealant 15 is formed with the PS 13. The common electrode 14 on the PS 13 is electrically connected to the pixel electrode 24 on the array substrate 20 by the com line to achieve the signal conducting of the upper and lower substrates.

As shown in FIG. 4, in the embodiment, the manufacturing process of CF substrate of the LCD panel includes manufacturing BM and color filter coating (RGB) sub-pixel on the glass substrate, forming PS, and manufacturing ITO filming. Therefore, on the final LCD panel, the surface of PS is covered by a layer of electrode, and the frame sealant area is also formed with PS. Thus, PS is made to replace the Au ball to achieve the signal transmission between the upper and lower substrates. Compared with the manufacturing process of the prior art shown in FIG. 2, the present invention omits the spread technology of the Au ball and the transfer pad reticle design, and the material demand of the Au ball can also be omitted.

In the embodiment of the present invention, the pixel electrode and the common electrode both are made of ITO material, this material has the advantages of better conductivity and light transmittance that has no influence on light transmittance of the pixel.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A manufacturing method of color film (CF) substrate, comprising: forming photo spacer (PS) on the CF substrate, and then forming an alignment layer on the CF substrate.

2. The manufacturing method of the CF substrate of claim 1, wherein the frame sealant setting area of the CF substrate is also formed with PS; correspondingly, the alignment layer is formed above all the PSs.

3. The manufacturing method of the CF substrate , comprises the steps:
A: forming a black matrix(BM) and a color filter coating;
B: forming PS;
C: forming alignment layer.

4. A liquid crystal display (LCD) panel, comprising: opposed array substrate and CF substrate; said CF substrate is formed with PS and an alignment layer, the surface of said PS opposite to said array substrate is covered by the alignment layer; the alignment layer on said PS is connected with the pixel electrode of the array substrate on said LCD panel by signal.

5. The LCD panel of claim 4, wherein the frame sealant setting area of said CF substrate is provided with PS, and the upper surface of said PS is covered by said alignment layer.

6. The LCD panel of claim 4, wherein the alignment layer on said PS contacts the pixel electrode of the array substrate on said LCD panel to perform signal connection.

7. The LCD panel of claim 4, wherein said electrode layer is made of ITO material.

8. An LCD device that comprises the LCD panel of claim 4, and said LCD panel comprises: opposed array substrate and CF substrate; said CF substrate is formed with PS and alignment layer, the surface of said PS opposite to said array substrate is covered by the alignment layer; the alignment layer on said PS is connected with the pixel electrode of the array substrate on said LCD panel by signal.

9. The LCD device of claim 8, wherein the frame sealant setting area of said CF substrate is provided with PS, and the upper surface of said PS is covered by said alignment layer.

10. The LCD device of claim 8, wherein the alignment layer on said PS contacts the pixel electrode of the array substrate on said LCD panel to perform signal connection.

11. The LCD device of claim 8, wherein said electrode layer is made of ITO material.
